(19) United States
(12) Patent Application Publication
(10) Pub. No.: US 2026/0008186 A1
(43) Pub. Date: Jan. 8, 2026

(54) WEARABLE ROLLER RINGS TO ENABLE ROBOT DEXTEROUS IN-HAND MANIPULATION THROUGH ACTIVE SURFACES

(71) Applicant: William Marsh Rice University

(72) Inventors: Kaiyu Hang, Houston, TX (US); Hayden M. Webb, Houston, TX (US); Shenli Yuan, Houston, TX (US)

(73) Assignee: William Marsh Rice University, (omitted)

(21) Appl. No.: 19/256,848

(22) Filed: Jul. 1, 2025

Related U.S. Application Data
(60) Provisional application No. 63/667,011, filed on Jul. 2, 2024.

(51) Int. Cl. B25J 15/00; B25J 9/00

(52) U.S. Cl. CPC B25J 15/0004; B25J 9/0006

(57) ABSTRACT

A wearable device and a method for enhanced in-hand manipulation of an object are disclosed. The wearable device includes a motor that drives a rotation of a first gear, where the first gear drives the rotation of a roller spur. The wearable device further includes an active surface that is rotationally driven around a rotation axis by the roller spur, where the active surface includes at least one contact point with the object. The wearable device further includes a hollow element operatively connected to the active surface.

### STATEMENT REGARDING FEDERALLY SPONSORED RESEARCH

This invention was made with government support under Grant No. FRR-2240040 awarded by the National Science Foundation. The government has certain rights in the invention.

### BACKGROUND

In-hand manipulation is a crucial ability for reorienting and repositioning objects within grasps. However, the main challenges are not only the complexity in the computational models, but also the risks of grasp instability caused by active finger motions, such as rolling, sliding, breaking, and remaking contacts. Accordingly, there exists a need to develop low-cost, easy-to-manufacture wearable devices that can enable and augment in-hand manipulation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a wearable device for enhanced in-hand manipulation of an object. The wearable device includes a motor that drives a rotation of a first gear, where the first gear drives the rotation of a roller spur. The wearable device further includes an active surface that is rotationally driven around a rotation axis by the roller spur, where the active surface includes at least one contact point with the object. The wearable device further includes a hollow element operatively connected to the active surface.

Embodiments disclosed herein generally relate to a method for enhanced in-hand manipulation of an object. The method includes providing a wearable device for enhanced in-hand manipulation of the object, where the wearable device includes an active surface with at least one contact point with the object. The method further includes generating, by a computer processor, a set of search values based on a search range and a search resolution. The method further includes, for each search value in the set of search values, determining, using the computer processor, an estimated angular velocity of the object based on the search value. The method further includes, for each search value in the set of search values, comparing, using the computer processor, the estimated angular velocity of the object with a target angular velocity of the object. The method further includes, for each search value in the set of search values, determining, based on the comparison, whether the estimated angular velocity of the object satisfies a predetermined criterion. The method further includes, for each search value in the set of search values, determining, using the computer processor and in response to the search value failing to satisfy the predetermined criterion, an updated search value. The method further includes determining a linear velocity of the object based, at least in part, on the updated search value. The method further includes actuating the object with the active surface based, at least in part, on the determined linear velocity.

### BRIEF DESCRIPTION OF DRAWINGS

Specific embodiments of the disclosed technology will be described in detail with reference to the accompanying figures. Like elements in the various figures are denoted by like reference numerals for consistency. Like elements may not be labeled in all figures for the sake of simplicity.

FIG. 1A depicts an exploded view of a wearable device, in accordance with one or more embodiments.

FIG. 1B depicts an assembled wearable device, in accordance with one or more embodiments.

FIG. 1C depicts Conformable Affixing Sleeve Module (CASM) variants for a wearable device, in accordance with one or more embodiments.

FIG. 1D depicts dimensions of each CASM variant, in accordance with one or more embodiments.

FIG. 2A depicts an in-hand rotation motion model for a unit sphere with two active surface contacts.

FIG. 2B depicts a unit sphere simultaneously actuated by active surfaces with the same velocity and the same contact force.

FIG. 2C depicts an illustration of a multi-sphere model for rotating arbitrary objects in-hand with active surface contacts.

FIG. 3 depicts object manipulation using a wearable device, in accordance with one or more embodiments.

FIG. 4A depicts a sphere rotated through all faces using a wearable device affixed to a robot hand.

FIG. 4B depicts a cheese toy translated and rotated using a wearable device affixed to a robot hand.

FIG. 4C depicts a cardboard tube translated a using a wearable device affixed to a robot hand.

FIG. 4D depicts a cube translated and rotated using a wearable device affixed to a human hand.

FIG. 5 depicts a flowchart, in accordance with one or more embodiments.

FIG. 6 depicts a computing system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “bearing” may include any number of “bearings” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

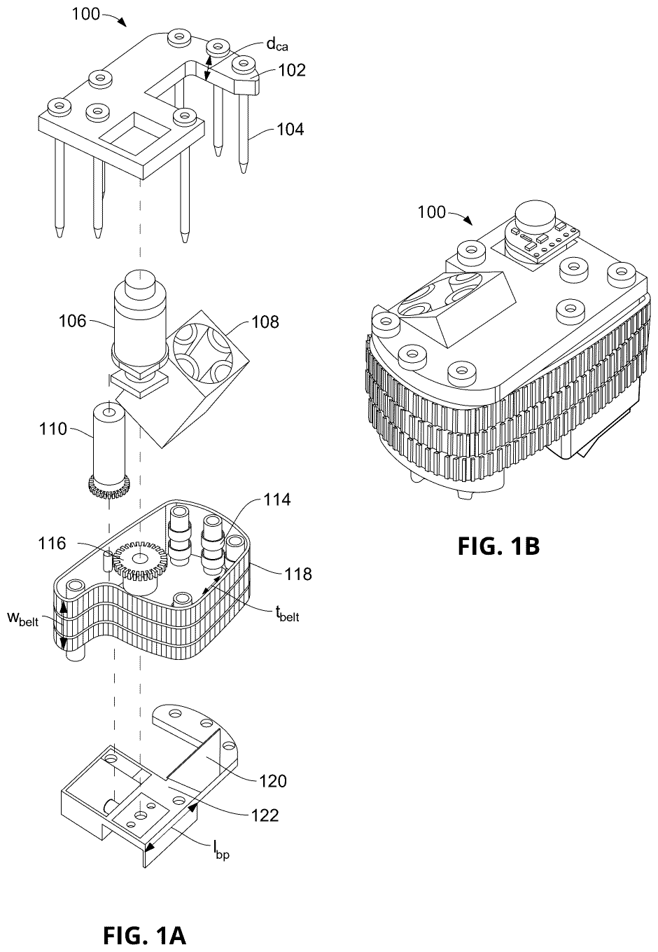

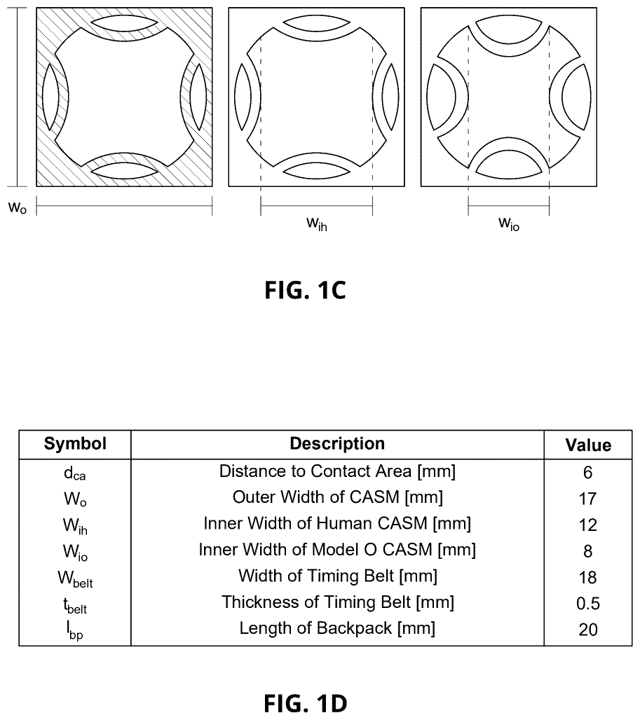

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

To physically engage robots with daily tasks, evolving new modalities of in-hand manipulation skills are crucial for addressing problems associated with the traditional manipulation paradigms. In the past decades, extensive studies have worked towards improving in-hand manipulation by developing new hand designs, computational models, and more integrated systems to not only mechanically provide better options, but also computationally and perceptually enhance their manipulation capabilities. Typically, in-hand manipulation is performed using precision grasps due to its robust dexterity. However, such hand-object configurations can come at the cost of stability and strength as limited by the small contacts at the fingertips. Moreover, due to the high degrees of freedom, precision grasp-based manipulation often relies on computationally complex, small-scale, and vulnerable movements to perform basic manipulations. Finger-gaiting, for example, requires the breaking of contacts to perform manipulations, which in turn compromises the grasp's total stability. In contrast, using power grasps is more stable but typically lacks the capability to perform the necessary relative motions between the object and hand. In-hand manipulation, in essence, is about stably maintaining and moving contacts with the manipulated object, but most traditional approaches fail to encompass both of these values.

To this end, a number of robot hands have been developed to fill in the aforementioned gaps. For example, to mitigate the concerns of grasp stability, underactuated hands have been designed to enable passive stability maintenance, while requiring significantly less degrees of control to be regulated for in-hand manipulation. Yet, such designs are limited to very small-scaled manipulation when utilizing manipulation techniques, such as finger-gaiting, due to their high complexity and ability to easily lose stability. Alternatively, palm support-based manipulation has been explored through compliant hand controls to greatly enlarge the manipulation ranges, however, without much consideration of the manipulation precision. The concept of active surfaces, which actively moves a grasp contact by directly translating the contact on the robot hand (e.g., via a conveyor belt) has created a new modality for in-hand manipulation. Robot hands with active surfaces are capable of performing dexterous manipulation without lifting a finger and, in theory, can translate the contacts without any limits as opposed to finger-gaiting. For rigid hands, motions actuated by active surfaces need to be precisely controlled to maintain the grasp stability. Recently, a hand design has further combined mechanical compliance and active surfaces into a hand design, enabling unprecedented in-hand manipulation skills without requiring complex computational models or control schemes. However, a major limitation of such hand design is that its capability cannot be directly transferred to any other hand design. Likewise, most active surface-based solutions develop their systems with this technique integrated into itself rather than having it be integrable into a system. On the other hand, robot grippers have shown their unique abilities in various in-hand manipulation tasks, as they allow the grasped object to be manipulated without the need to lift fingers during manipulation. However, their designs do not generalize to or enhance the capabilities of any existing hand designs.

Embodiments disclosed herein propose a design of a wearable device (“roller ring”) that can enable and augment active surface-based in-hand manipulation for any hands due to its modularity. Specifically, embodiments disclosed herein describe a wearable device for manipulation augmentation that is low-cost and easy to fabricate, a complete manipulation solution through differential manipulation motions, and a manipulation device attachable to any robot and human hands while not changing the existing capability of the original hands.

FIG. 1A depicts an illustration of a roller ring (100) in accordance with one or more embodiments. As discussed above, while active surfaces have shown promising capabilities for in-hand manipulation tasks, previous manipulation systems with active surfaces are limited to their underlying hand designs. Embodiments disclosed herein improve the manipulation capabilities of existing robot hands through the wearable and modular roller rings (100). With the integration of the roller rings (100), robot hands that are designed for various grasping and manipulation purposes with different form-factors have the ability to manipulate grasped objects without breaking contacts (i.e., lifting their fingers). To achieve this goal, the roller ring (100) design follows three design principles (“guiding principles”). First, the roller ring (100) provides a full spatial manipulation capability, i.e., moving a grasped object from an arbitrary initial pose to an arbitrary target pose within the workspace. Second, the roller ring (100) has a compact form factor allowing them to be operated without compromising the grasping ability of the hand that the roller rings (100) are mounted on. Third, the roller rings (100) are customizable in order for them to adapt to a wide range of robot hands and fingers.

As shown in FIG. 1A, the roller ring (100) includes a top plate (102), one or more shoulder screws (104), a motor (106), a hollow element (108), a roller spur (110), one or more bearings (114), a motor drive gear (116), an active surface (118), a guide track (120), and a bottom plate (122). All elements of the roller ring (100) are operatively connected with each other. FIG. 1B depicts a fully assembled roller ring (100) in accordance with one or more embodiments.

In one or more embodiments, the top plate (102) and the bottom plate (122) of the roller ring (100) are 3D-printed using Polylactic Acid (PLA) at a 30% infill. In one or more embodiments, the actuated active surface (118) and hollow element (108) are 3D-printed using Thermoplastic Polyurethane (TPU).

Each roller ring (100) variant has a one degree of freedom (DoF) active surface (118) that is achieved using a timing belt (118) routed through a series of needle bearings (114). As opposed to a 2-DoF, i.e., pivot and roll design, the single DoF design disclosed herein is used to minimize the form factor of the roller ring (100) in accordance with the guiding principles discussed above. Without an additional pivot joint, multiple roller rings (100) need to be used simultaneously and differentially in order to generate a net motion of the grasped object. The use of multiple roller rings (100) to generate a net motion of a grasped object is shown later in the instant disclosure.

In one or more embodiments, the timing belt (118) is driven by the motor (106) through the roller spur (110). In one or more embodiments, the motor (106) is a micro DC motor. In some embodiments, the motor (106) has a 210:1 gear ratio. As shown in FIG. 1A, the timing belt (118) is routed to minimize the footprint of the roller ring (100) model while satisfying the following constraints: (1) the timing belt (118) forms a convex active surface where the object is contacted, and (2) the timing belt (118) has enough contact area with the roller spur (110) to avoid the teeth skipping when operated. The surface pattern of the outer side of the timing belt (118) is designed to mate with the roller spur (110) teeth, which also doubles as a high friction surface for grasping and manipulation. In addition, it has grooves on the inner side to fit onto the needle bearings (114) and to constrain the lateral motion.

The roller ring (100) can be mounted on various grasping systems through a customizable the hollow element (108). In some embodiments, the grasping systems may include, but are not limited to, human hands, robotic end effectors, and robotic hand grippers. The modular 3D-printed hollow element (108) passively conforms to the grasping system when donned, and is easily removable and replaceable, allowing for zero cost installation and removal when used across a wide variety of grasping systems. In one or more embodiments, the hollow element (108) is a Conformable Affixing Sleeve Module (CASM). The CASM (108) is mounted on the guide track (120) of the roller ring (100).

To ensure that the roller ring (100) is generally wearable by any form of grasping system and abides by the guiding principles, the CASM (108) employs an inverted quatrefoil, as shown in FIG. 1C. This CASM design is chosen due to its ability to resist plastic deformation under high tension due to the combination of the filament and geometry's innate compliance. This compliance ensures that when the roller ring (100) is put on a grasping system, the interior correctly deforms to hold itself in place without long term degradation. This high level of compliance allows for the CASM (108) to be utilized in both the robot and human hand tests when using the designed variants for both grasping systems. These design variants for both grasping systems (human hand, subindex h, and robot hand, subindex o) are shown in FIG. 1C. FIG. 1D depicts the dimensions of each variable in the design.

The CASM (108) variants seen in FIG. 1C are designed following three constraints: (1) the outer width of the CASM (w₀) is at least 2 millimeters (mm) greater than the greatest width of the attachment point for the set of utilized grasping systems, (2) the quatrefoil's fins are at least 1 mm thick, and (3) the inner width (w₁) is at least 2 mm less than the attachment point. The CASM (108) variants correctly deform to the different grasping systems by following these parameters while still being attachable to the same roller ring (100). In one or more embodiments, w₀ is chosen to be 17 mm due to the human finger having the greatest width of the set at 15 mm, then the set of CASM's is parameterized from this baseline. Depictions of a select few dimensions of the roller ring (100) herein do not impose a limitation on the dimensions of the roller ring (100) encompassed by this disclosure. Further demonstration of the use of the CASM (108) designed variants for both grasping systems is described later in the instant disclosure.

As previously described, the guiding principle (1) specifies that the roller ring (100) is capable of performing full spatial manipulation. Considering that parallel finger configuration is common in multi-fingered grasping and manipulation, the active surface (118) is designed to be angled from the axis of the finger the roller ring (100) is mounted on, as shown in FIG. 1A. In a simplified model, the active surface (118) can be considered as a belt rotating around an axis of the CASM (108), wherein this tilted design reduces the likelihood of a situation where the rotation axes of multiple roller rings (100) are parallel. The design is generated in a way for the tilted angle to be easily changeable based on the specific grasping system used. If only two roller rings (100) are used, the active surfaces (118) of the two roller rings (100) arranged orthogonally will maximize the manipulability of the system. In one or more embodiments, a 30-degree) (°) angle between the active surface (118) and the CASM (108) is selected to balance the performance and form factor of the design.

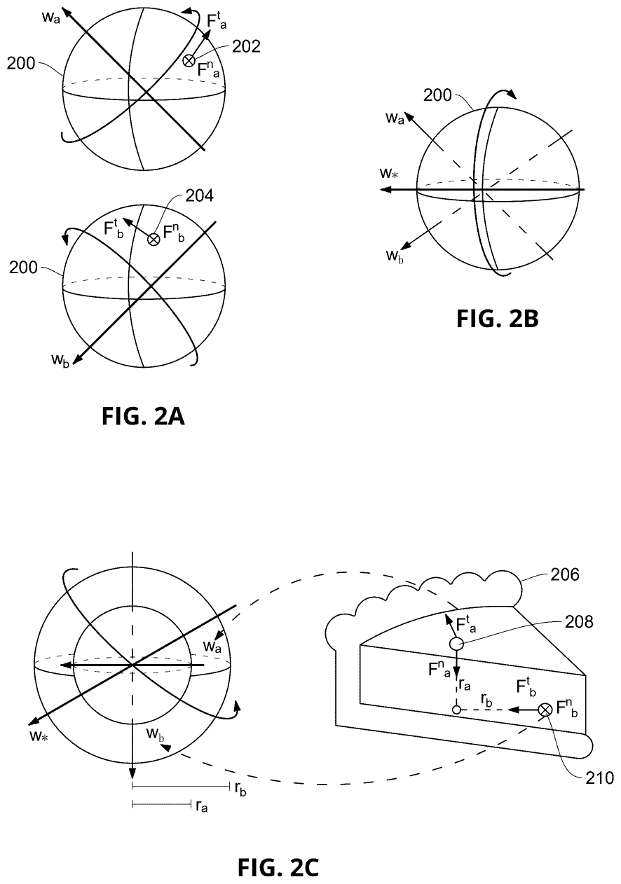

In accordance with one or more embodiments, a motion model focused on the in-hand rotation of a unit sphere is derived. FIG. 2A depicts the in-hand rotation motion model for a unit sphere (200) with two active surface contacts: contact point a (202) (pₐ) and contact point b (204) (p_{b}). As shown in FIG. 2A, by making contact with an active surface at a point pₐ (202) in the sphere (200), the linear motion of the active surface at this contact will generate a torque to this sphere (200) with respect to its center. This torque is mathematically given by:

$${τ}_{a} = {p}_{a} \times {F}_{a}^{t} \qquad Equation ( 1 )$$

In EQ. 1,

$${F}_{a}^{t}$$

is the tangential friction for at point a, which is determined by the contact normal force

$${F}_{a}^{n}$$

and the friction coefficient μ follows:

$$\vert {F}_{a}^{t} \vert \leq μ \vert {F}_{a}^{n} \vert .$$

Depending on the relative linear motion between the active surface and the sphere (200) at point pₐ (202), the direction of the force

$${F}_{a}^{t}$$

a can vary, but the magnitude stays constant when the two contacting surfaces are “slipping or scratching” against each other.

With this single active surface contact that moves with a linear velocity vₐ, the sphere (200) will accelerate the rotation to synchronize its motion at the point pₐ until the two surfaces in contact do not slip, resulting in an angular velocity of the object ωₐ that satisfies:

$${v}_{a} = {ω}_{a} \times {p}_{a} \qquad Equation ( 2 )$$

In EQ. 3, ωₐ=θ_{α}ω_{α} is expressed by the angular velocity θ₂ and an axis of rotation

$${\hat{ω}}_{a} = \frac{{ω}_{a}}{\vert {ω}_{a} \vert} .$$

Similarly, as shown in FIG. 2A, if there is a single active surface contact p_{b} (204) that moves at a speed of v_{b}, the angular velocity of the sphere (20) caused by this contact alone is ω_{b} and it satisfies: V_{b}=ω_{b}×p_{b}.

If both contacts pₐ (202) and p_{b} (204) are made with active surfaces, the sphere (200) will then initially start rotating still with “slipping” contacts. However, unless the two active surface motions are co-linear (in terms of the rotation axes), the resultant or converged motion at equilibrium will still be “slipping” to balance between the torque differences generated by the two contacts (202, 204). To derive the object motion model based on the motions of these two active surface contacts, the goal is to find the angular velocity ω, of the sphere (200) when all “scratching or slipping” forces are balanced. The linear velocities of the sphere (200) at the contacts are:

$${v}_{a}^{*} = {ω}_{*} \times {p}_{a} and {v}_{b}^{*} = {ω}_{*} \times {p}_{b} \qquad Equation ( 3 )$$

In EQ. 3,

$${v}_{a}^{*} and {v}_{b}^{*}$$

are different from the linear velocities vₐ and v_{b} of the two active surface contacts (202, 204). As discussed above, this will cause “slipping motions” at both contacts (202, 2024), where the motions of the active surfaces relative to the object are given by:

$${v}_{a} - {v}_{a}^{*} and {v}_{b} - {v}_{b}^{*} .$$

Such slippage results in tangential forces at the contacts aligned to the relative motion directions:

$${τ}_{a}^{*} = {p}_{a} \times ( μ \vert {F}_{a}^{n} \vert \frac{{v}_{a} - {v}_{a}^{*}}{\vert {v}_{a} - {v}_{a}^{*} \vert} ) = {k}_{a} {p}_{a} \times ( {v}_{a} - {v}_{a}^{*} ) \qquad Equation ( 4 )$$

$${τ}_{b}^{*} = {p}_{b} \times ( μ \vert {F}_{b}^{n} \vert \frac{{v}_{b} - {v}_{b}^{*}}{\vert {v}_{b} - {v}_{b}^{*} \vert} ) = {k}_{b} {p}_{b} \times ( {v}_{b} - {v}_{b}^{*} )$$

In EQ. 4,

$${k}_{a} = \frac{μ \vert {F}_{a}^{n} \vert}{\vert {v}_{a} - {v}_{a}^{*} \vert} and {k}_{b} = \frac{μ \vert {F}_{b}^{n} \vert}{\vert {v}_{b} - {v}_{b}^{*} \vert}$$

are scalar scaling factors determined by the magnitudes of both the contact forces and the relative velocities. When the object motion is at equilibrium (i.e., there is zero effective torque applied by the contacts) its motion will stabilize and the torques at both contacts should satisfy.

$${τ}_{a}^{*} + {τ}_{b}^{*} = 0 ,$$

$${k}_{a} {p}_{a} \times ( {v}_{a} - {v}_{a}^{*} ) = - {k}_{b} {p}_{b} \times ( {v}_{b} - {v}_{b}^{*} ) \qquad Equation ( 5 )$$

Using that ω=p×v yields:

$${k}_{a} \times ( {ω}_{a} - {ω}_{*} ) = - {k}_{b} \times ( {ω}_{b} - {ω}_{*} ) \qquad Equation ( 6 )$$

In EQ. 6, ωₐ and ω_{b} are the angular velocities independently generated by the contacts (202, 204). Rearranging EQ. 6, yields an expression of the object's angular velocity:

$${ω}_{*} = \frac{{k}_{a} {ω}_{a} + {k}_{b} {ω}_{b}}{{k}_{a} + {k}_{b}} \qquad Equation ( 7 )$$

EQ. 7 shows that the angular velocity of the sphere (200), as simultaneously actuated by two active surfaces, is a weighted sum of the angular velocities of the object when it is actuated by each contact independently. The weights kₐ and k_{b} are determined by the contact force and the intrinsic velocities of the active surfaces themselves. In other words, the difference between the velocities of the active surfaces will directly determine the object's motion ω. As such, the motion model described above is a differential motion model. A differential motion model is a type of kinematic model used to describe how an object moves based on differential (relative) changes in position or orientation over time, rather than using absolute coordinates. Intuitively, rotating the object with motions more biased by a contact can be done by increasing the contact force or by speeding up the corresponding active surface. FIG. 2B shows an example of a sphere (200) with two contact points simultaneously actuated by active surfaces with the same velocity and the same contact force. In such case, EQ. 7 yields: ωₐ=(ωₐ+ω_{b})/2.

Assuming non-colinear configurations of the active surfaces, the object's motion can be activated to rotate about multiple axes of rotation. Generally, as long as a hand-object system can rotate an object about at least two orthogonal axes, the object can be reoriented from any angle to any other angle. The set of axes of rotation generated by EQ. 7 can be projected to provide rotations about orthogonal pairs of axes. Therefore, EQ. 7 demonstrates that with as few as only two active surfaces, a complete rotational manipulation solution can be provided.

Furthermore, EQ. 7 can be extended to N active surface contacts, which provides more axes of rotation. The motion model in this case becomes:

$${ω}_{*} = \frac{{\sum }_{i = 1}^{N} {k}_{i} {ω}_{i}}{{\sum }_{i = 1}^{N} {k}_{i}} \qquad Equation ( 8 )$$

In accordance with one or more embodiments, the rotation motion model on a unit sphere (200) described above can be extended to an in-hand rotation model of arbitrary object shapes. FIG. 2C depicts an illustration of a multi-sphere model for rotating an arbitrary object (206) in-hand with active surface contacts. FIG. 2C shows two contact points on the object (206): contact point a (208) (pₐ) and contact point b (210) (p_{b}). However, the contacts are not necessarily on a unit sphere (200) in this case. The distance between the contact points (206, 208) to the axis of rotation is represented by rₐ and r_{b}. Intuitively, these two contacts are actuating the object (206) as if there were 2 different spheres for them to make contacts. As such, the torques generated by these two contacts are now additionally scaled by rₐ and r_{b}:

$${τ}_{a}^{*} = {r}_{a} {k}_{a} {p}_{a} \times ( {v}_{a} - {v}_{a}^{*} ) \qquad Equation ( 9 )$$

$${τ}_{b}^{*} = {r}_{b} {k}_{b} {p}_{b} \times ( {v}_{b} - {v}_{b}^{*} )$$

Similarly to the derivation of the motion model on a unit sphere (200) described above, the torques should all balance out when the object is rotating at an equilibrium state. Therefore, the rotation motion model for N active surface contacts on arbitrary objects (206) is mathematically given by:

$${ω}_{*} = \frac{{\sum }_{i = 1}^{N} {r}_{i} {k}_{i} {ω}_{i}}{{\sum }_{i = 1}^{N} {r}_{i} {k}_{i}} \qquad Equation ( 10 )$$

Based on this multi-sphere motion model, EQ. 10 provides a complete and non-holonomic rotational manipulation solution. However, a major difference now is that the individual angular velocities are additionally weighted by the distances between the contact and the rotation axis, as shown in EQ. 10, thus providing another dimension for rotations to be regulated by contact variances.

In accordance with one or more embodiments, to achieve a complete in-hand manipulation solution, the final component required in the motion model is the ability to translate the object in-hand. The model analysis described below focuses on pure translations supplementary to the rotation models derived above. In practice, however, the object rotation and translation can happen simultaneously during manipulation in order to perform more efficient actions.

For pure in-hand object translation, the first requirement is that the object's angular velocity should be zero. Based on the model above, this can be expressed as a motion constraint among all active surfaces:

$${ω}_{*} = {\sum }_{i = 1}^{N} {r}_{i} {k}_{i} {ω}_{i} .$$

When this constraint is satisfied, which can be achieved in an infinite number of ways when multiple contacts exist to cancel out each other's torques, the velocity of the object is purely determined by the linear forces provided by the active surfaces. If v* is the linear velocity of the object, vᵢ is the linear velocity of the i-th active surface, and

$${F}_{i}^{t}$$

is the tangential force at the i-th active surface, the following equation further constrains the object's translation:

$${\sum }_{i = 1}^{N} {F}_{i}^{t} \cdot \frac{{v}_{i} - {v}^{*}}{\vert {v}_{i} - {v}^{*} \vert} \cdot \frac{{v}_{i} \times {v}^{*}}{\vert {v}_{i} \times {v}^{*} \vert} = 0 \qquad Equation ( 11 )$$

In EQ. 11, the tangential force at each contact is first aligned to the direction of the “slipping or scratching” motion and then projected to the orthogonal direction of the object's motion by the dot product. The zero-sum of all these forces guarantees that the object is purely translating in the direction of v*.

In accordance with one or more embodiments, assuming that the contact forces

$${F}_{i}^{n}$$

and contact radii rᵢ are determined by the grasp and given, embodiments disclosed herein search over a fine grid of all possible combinations of velocities vᵢ, which directly determine kᵢ, and check which combinations result in the desired ωₐ. If multiple solutions exist, the solution with the minimum sum of vᵢ is chosen. If a solution is not found, the grid resolution is increased, as used by grid search, and a new search is performed until a solution is found. In accordance with one or more embodiments, the search method satisfies a predetermined criterion. For example, the predetermined criterion may require updating the solution until the solution has minimal change. The minimal change may be selected by a user (e.g., reaching a level of convergence where the standard deviation is below 1e-2 over the past 20 loss updates) or automatically determined by the search method based, for example, on past iterations. In one or more embodiments, the predetermined criterion may be a stopping criterion, such that the search is performed for a fixed number of iterations (e.g., 2000) until the stopping criterion is met. In some embodiments, the search method is a Newton-Raphson method. However, other search methods are also contemplated such as a secant method or a bisection method. Given this comprehensive solution of in-hand rotation, the object can be manipulated from any pose to any other by sequencing translation and rotations. Therefore, combining the in-hand translation motion model with the rotation motion model results in a complete set of in-hand manipulation solutions.

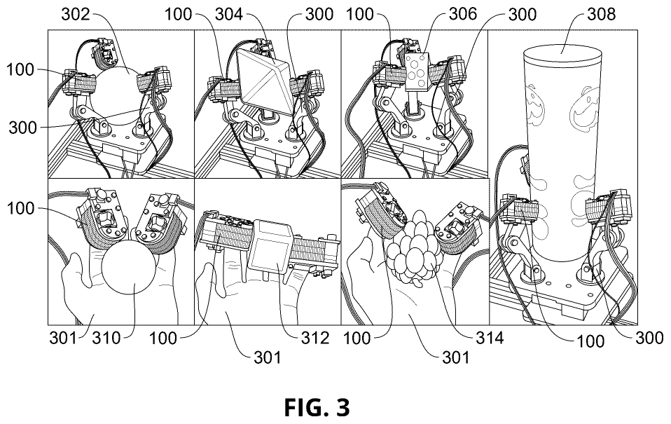

To evaluate the design and motion model of the roller ring (100), the prototype shown in FIGS. 1A and 1B was built to test its in-hand manipulation capabilities using various objects. FIG. 3 shows the manipulated experimental objects, which includes an A-F sphere (302), an octahedron (304), a cheese toy (306), and a cardboard tube (308) affixed to a robot hand (300). In addition, FIG. 3 shows another A-F Sphere (310), a cube (312), and a grape toy (314) affixed to a human hand (301).

In accordance with one or more embodiments, each roller ring (100) variant has one actuated DoF from the motor (106) that is controlled using velocity control. Each roller ring (100) has its velocity set to a differing set of values during experiments, such that the combinations of varying velocities can generate differential motions for the grasped object, thus allowing for a complete manipulation solution. All experiments disclosed herein are conducted using teleoperation.

In accordance with one or more embodiments, while conducting the experiments, the range of rotation that was physically possible by the roller rings (100) was evaluated through their combined set of actuated DoFs. In doing this, so long as the manipulated object's geometry did not collide internally with the grasping system and a stable grasp was maintained, the goal was to confirm that the designed roller rings (100) could rotate a grasped object from any initial orientation to any other goal orientation, so as to verify the rotational manipulation solutions derived above.

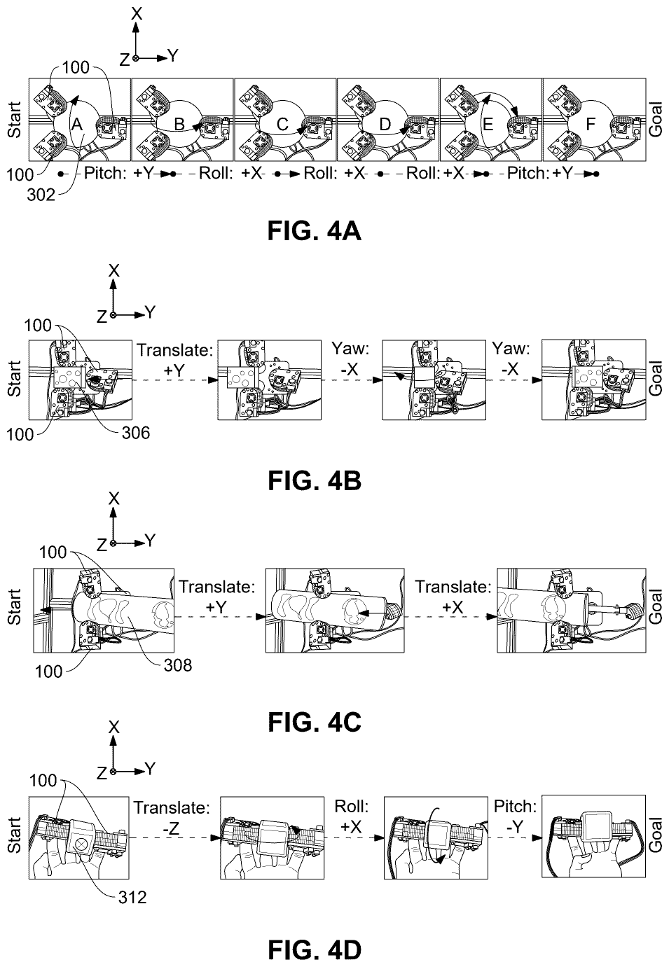

FIG. 4A shows the AF sphere (302) being grasped and manipulated by a robot hand (300) using the single-sphere motion model described above. As shown in FIG. 4A, the AF sphere (302) can be rotated to any face using three roller rings (100) and a combination of pitch and roll movements. These rotations can be performed about multiple axes. The cheese toy (306) is also rotated to any desired orientation, as shown in FIG. 4B. The experimental results shown in FIGS. 4A and 4B demonstrate the in-hand rotation capability of the roller ring (100) design, as well as the correctness of the multi-sphere motion model. Furthermore, FIGS. 4A and 4B demonstrate that the grasping system used (e.g., robot hand (300) and human hand (301)) makes no difference in the ability to fully rotate the grasped objects.

After confirming the ability of a full range of reorientation, the translational manipulation of the roller rings (100) is tested. Specifically, the translational portion of the motion model (EQ. 11) is used to generate translations along all cardinal planes from the base set of the actuated roller rings (100). Following the same constraints as the rotational manipulation, so long as the object is stably grasped and does not collide internally with the hand, translations can be generated. FIGS. 4B-4D are examples showing both translations and rotations generated for grasped objects, including a cheese toy (306) in FIG. 4B, a carboard tube (308) in FIG. 4C, and a cube (312) in FIG. 4D, to move them within the grasping system. Similarly to the rotational manipulation, FIGS. 4B-4D show that the form of grasping system made no difference whether the roller rings (100) were affixed to a human or robot grasping system in terms of manipulation capabilities. Therefore, the experimental results shown in FIGS. 4A-4D demonstrate that, as long as the grasping constraints are met, rotations and translations can be generated in sequences to fully manipulate the in-hand object from any pose to any others.

Embodiments of the present disclosure may provide at least one of the following advantages. The roller ring (100) provides dexterous and robust manipulation of an object (124) without lifting a finger when worn, as it is less likely to drop the object (124) when manipulating. Further, the roller ring (100) improves and augments the manipulation capabilities of existing grasping systems (e.g., human hands, robotic end effectors, robotic hand grippers, etc.). In addition, the roller ring (100) size or scale can vary depending on the application, and the roller ring (100) may be worn anywhere on robot or human bodies including, but not limited to, fingertips, between fingertips, palms, wrists, arms, elbows, legs, feet. Additionally, the roller ring (100) is compatible with and can be used together with traditional contact designs, such as classic robot fingertips, to improve manipulation skills. Moreover, the roller ring (100) may not only enable manipulation skills but also enhance mobility of robots or humans when worn on locations that will be in contact with the ground or floor. In general, embodiments of the present disclosure provide a general formulation and a base meta-algorithm for building any active surface-based manipulation system.

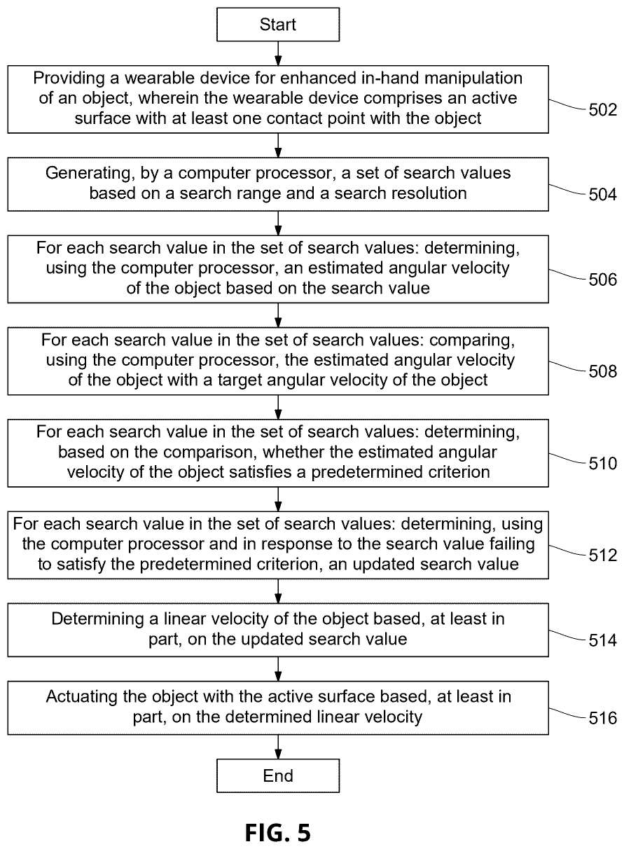

FIG. 5 depicts a method for enhanced in-hand manipulation of an object, in accordance with one or more embodiments. In Block 502, a wearable device for enhanced in-hand manipulation of the object is provided. The wearable device includes an active surface with at least one contact point with the object. In Block 504, a set of search values is generated using a computer processor. The search values are based on a search range and a search resolution. In Block 506, for each search value in the set of search values, an estimated angular velocity of the object is determined, using the computer processor, based on the search value. In Block 508, for each search value in the set of search values, the estimated angular velocity of the object is compared, using the computer processor, with a target angular velocity of the object. Different metrics, such as mean square error (MSE) and root mean square error (RMSE), may be used to compare the estimated angular velocity with the target angular velocity of the object. In Block 510, for each search value in the set of search values, a determination is made based on the comparison whether the estimated angular velocity of the object satisfies a predetermined criterion. For example, the predetermined criterion may require updating the solution until the solution has minimal change. The minimal change may be selected by a user (e.g., reaching a level of convergence where the standard deviation is below 1e-2 over the past 20 loss updates) or automatically determined by the search method based, for example, on past iterations. In one or more embodiments, the predetermined criterion may be a stopping criterion, such that the search is performed for a fixed number of iterations (e.g., 2000) until the stopping criterion is met. In some embodiments, the search method is a Newton-Raphson method. However, other search methods are also contemplated such as a secant method or a bisection method. In Block 512, for each search value in the set of search values, an updated search value is determined, using the computer processor, in response to the search value failing to satisfy the predetermined criterion. In Block 514, a linear velocity of the object is determined based, at least in part, on the updated search value. In Block 516, the object is actuated with the active surface based, at least in part, on the determined linear velocity.

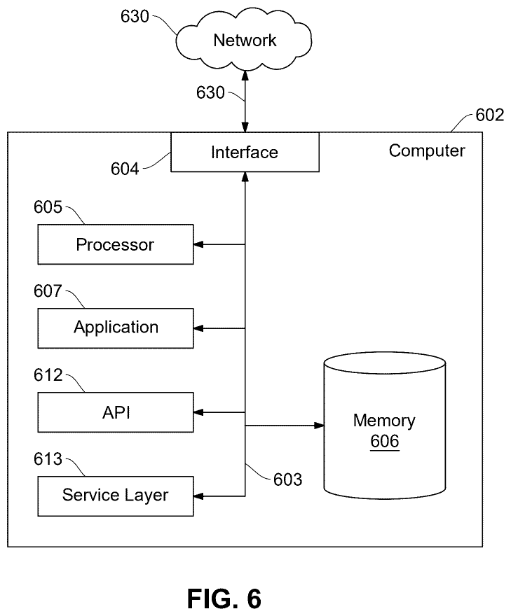

Embodiments disclosed herein may be implemented on a computer system. FIG. 6 is a block diagram of a computer system (602) used to provide computational functionalities associated with described algorithms, methods, functions, processes, flows, and procedures as described in the instant disclosure, according to one or more embodiments. For example, in one or more embodiments, the computer system (602) performs a search to determine the linear velocity of an object and executes the motion model (EQs. 8, 10, and 11). The motion model is used to actuate the object with the active surface (118) based on the linear velocity determined using the computer system (602). The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts.

Additionally, the computer (602) may include a computer that includes an input device, such as a keypad, keyboard, touch screen, or other device that may accept user information, and an output device that conveys information associated with the operation of the computer (602), including digital data, visual, or audio information (or a combination of information), or a GUI.

The computer (602) may serve in a role as a client, network component, a server, a database or other persistency, or any other component (or a combination of roles) of a computer system for performing the subject matter described in the instant disclosure. In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) may receive requests over network (630) from a client application (for example, executing on another computer (602) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) may communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that may be connected to the network (630). The memory may be a non-transitory computer readable medium. For example, memory (606) may be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) may be external to the computer (602).

The application (607) is an algorithmic software engine providing functionality according to particular needs, desires, or particular implementations of the computer (602), particularly with respect to functionality described in this disclosure. For example, application (607) may serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) may be external to the computer (602).

There may be any number of computers (602) associated with, or external to, a computer system containing computer (602), wherein each computer (602) communicates over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

What is claimed:

1. A wearable device for enhanced in-hand manipulation of an object, comprising:
a motor that drives a rotation of a first gear, wherein the first gear drives the rotation of a roller spur;
an active surface that is rotationally driven around a rotation axis by the roller spur, wherein the active surface comprises at least one contact point with the object; and
a hollow element operatively connected to the active surface.

2. The wearable device of claim 1,
wherein the active surface is routed through one or more bearings,
wherein the one or more bearings comprises needle bearings.

3. The wearable device of claim 1, further comprising:
a top plate, wherein the top plate comprises one or more shoulder screws; and
a bottom plate.

4. The wearable device of claim 1,
wherein the hollow element comprises a Conformable Affixing Sleeve Module (CASM),
wherein the CASM is tilted with respect to the rotation axis, and
wherein the CASM is mounted on a guide track.

5. The wearable device of claim 1, wherein the motor comprises a DC motor.

6. The wearable device of claim 1,
wherein the active surface comprises a convex active surface, and
wherein the active surface comprises a timing belt.

7. The wearable device of claim 1, wherein the active surface further comprises:
an inner surface comprising an inner surface groove, wherein the inner surface groove fits onto one or more bearings; and
an outer surface comprising an outer surface pattern, wherein the outer surface pattern is in contact with the roller spur.

8. The wearable device of claim 7,
wherein the roller spur comprises one or more gear teeth, and
wherein the outer surface pattern mates with the one or more gear teeth.

9. The wearable device of claim 4,
wherein the wearable device is mounted on a grasping system by customization of the CASM,
wherein the grasping system comprises a human hand and a robot hand.

10. The wearable device of claim 9, wherein the CASM further comprises:
an inverted quatrefoil design comprising one or more quatrefoil fins, wherein an outer width of the CASM is at least 2 millimeters greater than a greatest width of an attachment point for the grasping system,
wherein a thickness of the one or more quatrefoil fins is at least 1 millimeter, and
wherein an inner width of the one or more quatrefoil fins is at least 2 millimeters less than the attachment point.

11. The wearable device of claim 1,
wherein the receptacle affixes the active surface to a robot and a human body, and
wherein the wearable device can be worn anywhere on the robot and the human body including fingertips and feet.

12. The wearable device of claim 1, wherein the wearable device enables contact-based manipulation using a plurality of wearable devices in combination.

13. A method for enhanced in-hand manipulation of an object, the method comprising:
providing a wearable device for enhanced in-hand manipulation of the object, wherein the wearable device comprises an active surface with at least one contact point with the object;
generating, by a computer processor, a set of search values based on a search range and a search resolution;
for each search value in the set of search values:
determining, using the computer processor, an estimated angular velocity of the object based on the search value;
comparing, using the computer processor, the estimated angular velocity of the object with a target angular velocity of the object;
determining, based on the comparison, whether the estimated angular velocity of the object satisfies a predetermined criterion;
determining, using the computer processor and in response to the search value failing to satisfy the predetermined criterion, an updated search value;
determining a linear velocity of the object based, at least in part, on the updated search value; and
actuating the object with the active surface based, at least in part, on the determined linear velocity.

14. The method of claim 13, further comprising:
determining, in response to one or more search values satisfying the predetermined criterion, the linear velocity of the object based on a minimization of a total linear velocity,
wherein the total linear velocity comprises a sum of linear velocities at each contact point.

15. The method of claim 13, further comprising:
increasing the search resolution in response to all search values failing to satisfy the predetermined criterion.

16. The method of claim 13,
wherein the search value is updated iteratively until the predetermined criterion is satisfied,
wherein the predetermined criterion is a predetermined level of accuracy.

17. The method of claim 13, wherein the set of search values comprises a set of linear velocities at each contact point.

18. The method of claim 17, further comprising:
for each linear velocity in the set of linear velocities:
for each contact point:
obtaining a contact radius at the contact point, wherein the contact radius comprises a distance from the rotation axis to the contact point;
determining a scaling factor at the contact point based on the linear velocity;
determining an angular velocity of the object at the contact point based on the linear velocity; and
determining the linear velocity of the object based, at least in part, on the contact radius, the scaling factor at the contact point, and the angular velocity at each contact point.

19. The method of claim 18, wherein determining the scaling factor comprises:
for each contact point:
obtaining a friction coefficient at the contact point;
obtaining a contact force at the contact point, wherein the wearable device is configured to determine the contact force; and
obtaining a linear velocity of the active surface at the contact point.

20. The method of claim 13, wherein actuating the object with the active surface comprises rotating and translating the object.
